(19) United States
(12) Patent Application Publication
(10) Pub. No.: US 2015/0362056 A1
(43) Pub. Date: Dec. 17, 2015

(54) HARMONIC DRIVE ACHIEVING A HIGH MESHING EFFICIENCY

(71) Applicant: HIWIN TECHNOLOGIES CORP., TAICHUNG CITY (TW)

(72) Inventors: YI-HUNG TSAI, TAICHUNG CITY (TW); FUNG-LING NIAN, TAICHUNG CITY (TW); JHE-HONG WANG, TAICHUNG CITY (TW)

(21) Appl. No.: 14/471,862

(22) Filed: Aug. 28, 2014

(30) Foreign Application Priority Data
Jun. 16, 2014 (TW) 103120761

(51) Int. Cl. F16H 49/00

(52) U.S. Cl. CPC F16H 49/001; F16H 2049/003

(57) ABSTRACT

A harmonic drive includes a circular spline, a flexspline meshed with the circular spline, and a wave generator abutted against the flexspline. Through a special parameter design to correct the perimeter curve of the wave generator, the meshing efficiency between the circular spline and the flexspline is increased, thereby improving the transmission accuracy and reducing the average load.

### BACKGROUND OF THE INVENTION

1. Field of the Invention

The present invention relates to speed reducing gear technology, and more particularly, to a harmonic drive that achieves a high meshing efficiency.

2. Description of the Related Art

Harmonic drive is a high-ratio speed reducer. A conventional harmonic drive generally comprises a circular spline, a flexspline rotatably mounted within the circular spline, and a wave generator rotatably mounted within the flexspline, wherein the wave generator is an elliptical member. When the wave generator is driven to rotate by a power source, the flexspline will be pushed to deform by the outer perimeter of the wave generator, causing the circular spline to mesh with the flexspline in the major axis of the wave generator and to be disengaged from the flexspline in the minor axis of the wave generator. Due to a difference in the number of teeth between the circular spline and the flexspline, a high speed reduction ratio will be achieved to provide a high torque output after the wave generator is been continuously rotated.

Thus, the higher the meshing efficiency between the circular spline and the flexspline is, the better the overall transmission accuracy and the lower the average load of the teeth will be. However, the meshing efficiency between the circular spline and the flexspline depends on the change in curvature between the major axis and minor axis of the wave generator. In order to optimize the change in curvature between the major axis and minor axis of the wave generator, Japanese Patent Nos. 4067037 and 5256249 disclose a measure of correcting the curvatures of the major axis and minor axis of a wave generator. However, the correction equation used in the aforesaid prior art patents is complicated, further, the effect of the correction is not as good as expected.

### SUMMARY OF THE INVENTION

The present invention has been accomplished under the circumstances in view. It is the main object of the present invention to provide a harmonic drive, which uses a simple parameter design to achieve the effects of improving the meshing efficiency and transmission precision and reducing the average load of the teeth.

To achieve this and other objects of the present invention, a harmonic drive comprises a circular spline, a flexspline, and a wave generator. The circular spline comprises an inner annular toothed portion. The flexspline is rotatably mounted within the circular spline, comprising an outer annular toothed portion meshed with the inner annular toothed portion of the circular spline. The wave generator is rotatably mounted within the flexspline, comprising an elliptical outer perimeter abutted against an inner perimeter of the flexspline. The radius of curvature of the elliptical outer perimeter of the wave generator is defined as r·r=+√x²+y², the relationship between x and y satisfying the elliptical parametric equation: x={a +Cₐ×(sin (4θ−(π/2))+1)}×sin θ, y={b+C_{b}×(sin (4θ−(π/2))+1)}×sin θ, 0≦θ≦2π, wherein a is the semi-major axis of the elliptical outer perimeter of said wave generator; Cₐ is the semi-major axis correction factor; b is the semi-minor axis of the elliptical outer perimeter of said wave generator; C_{b} is the semi-minor axis correction factor; θ is the eccentric angle of the elliptical outer perimeter of said wave generator.

Thus, during the operation of the wave generator to rotate the flexspline relative to the circular spline after the correction of the curvature of the outer perimeter of the wave generator, the number of teeth of mesh between the outer annular toothed portion of the flexspline and the inner annular toothed portion of the circular spline is increased to achieve a high meshing efficiency and a high level of transmission accuracy of the whole structure and to reduce the average load of the teeth.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic structural view of a harmonic drive in accordance with the present invention.

FIG. 2 is a schematic drawing illustrating the correction of the curvature of the wave generator in accordance with the present invention.

### DETAILED DESCRIPTION OF THE INVENTION

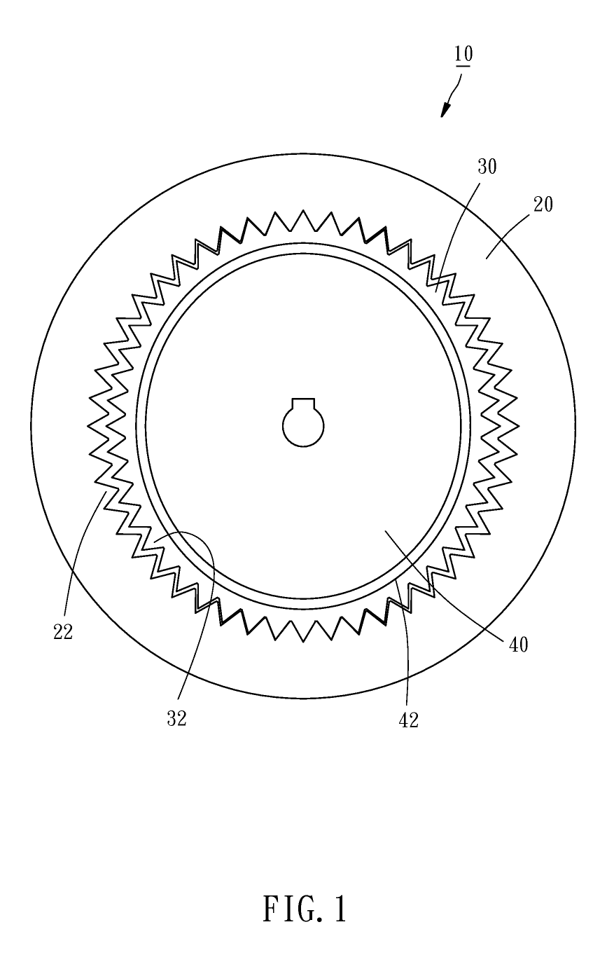

Referring to FIG. 1, a harmonic drive 10 in accordance with the present invention comprises a circular spline 20, a flexspline 30, and a wave generator 40.

The circular spline 20 comprises an inner annular toothed portion 22. The flexspline 30 is mounted within the circular spline 20, comprising an outer annular toothed portion 32 facing toward the inner annular toothed portion 22 of the circular spline 20. It is to be noted that the number of teeth of the inner annular toothed portion 22 of the circular spline 20 is 2 more than the number of teeth of the outer annular toothed portion 32 of the flexspline 30. Further, the circular spline 20 and the flexspline 30 have a same modulus therebetween. The modulus referred to therein is the quotient obtained by dividing the gear pitch diameter by the number of teeth.

The wave generator 40 is mounted within the flexspline 30, comprising an elliptical outer perimeter 42. When the wave generator 40 is driven to rotate by a power source (not shown), the flexspline 30 will be pushed and deformed by the outer perimeter 42 of the wave generator 40, causing the inner annular toothed portion 22 of the circular spline 20 to be completely meshed with the outer annular toothed portion 32 of the flexspline 30 in the major axis direction of the wave generator 40 and completely disengaged from the outer annular toothed portion 32 of the flexspline 30 in the minor axis direction of the wave generator 40. Thus, the circular spline 20 can be rotated by the flexspline 30 to achieve the effect of torque output.

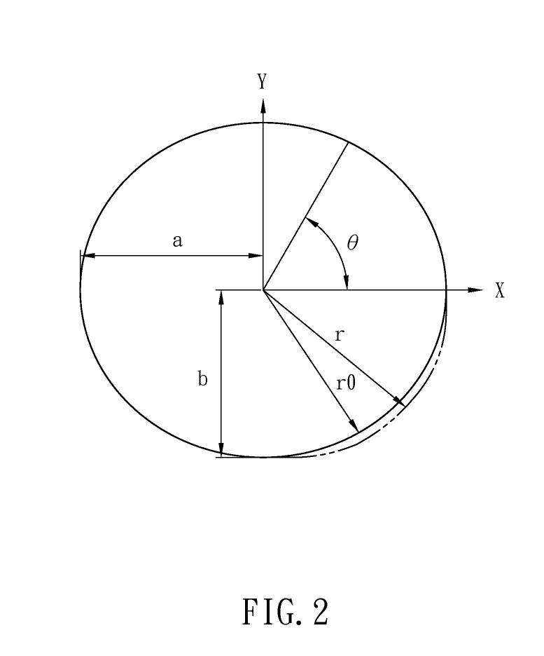

Referring to FIG. 2, before correcting the outer perimeter 42 of the wave generator 40, obtain the initial radius of curvature r₀ of the outer perimeter 42 of the wave generator 40 by equation (1) r₀=√(a sin θ)²+(b sin θ)², 0≦θ≦2π in which a: the semi-major axis of the outer perimeter 42 of the wave generator 40; b: the semi-minor axis of the outer perimeter 42 of the wave generator 4; θ: the eccentric angle of the outer perimeter 42 of the wave generator 40. Thereafter, obtain the initial perimeter S₀ of the outer perimeter 42 of the wave generator 4 by equation (2) S₀=∫f₀^{2π}√φ_{θ}(r₀)²+r₀²

In correction, obtain the corrected perimeter S of the outer perimeter 42 of the wave generator 4 by equation (3) E_{S}=S−S₀=0.1 m˜0.8 m, in which Eₛ: the variable quantity of the outer perimeter 42 of the wave generator 40 before/after correction; m: modulus of the circular spline 20 or flexspline 30. Thereafter, apply equation (4) S=∫₀^{2π}√φ_{θ}(r)²+r² to obtain the corrected radius of curvature r of the outer perimeter 42 of the wave generator 40, and then apply equation (5) to obtain the relationship between x and y. The coordinate (x, y) of any point at the outer perimeter 42 of the wave generator 40 after the correction must satisfy the following elliptical parametric equation: x={a +Cₐ×(sin (4θ−(n/2))+1)}×sin θ, y={b+C_{b}×(sin (4θ−(n/2))+1)}×sin θ, 0≦θ≦2π, wherein Cₐ is the semi-major axis correction factor; C_{b} is the semi-minor axis correction factor. Thus, the relationship between Cₐ and C_{b} can be obtained through equation (5) and the aforesaid elliptical parametric equation, and then the relationship between Cₐ and C_{b} can be used to correct the outer perimeter 42 of the wave generator 40 to the optical elliptic curve.

Thus, during the operation of the wave generator 40 to rotate the flexspline 30 relative to the circular spline 20 after the correction of the curvature of the outer perimeter 42 of the wave generator 40, engaging and disengaging frequency between the outer annular toothed portion 32 of the flexspline 30 and the inner annular toothed portion 22 of the circular spline 20 is increased, thereby increasing the number of teeth in mesh, and thus, the harmonic drive can achieve a high meshing efficiency and a high level of transmission accuracy and can also reduce the average load of the teeth.

What is claimed is:

1. A harmonic drive, comprising:
a circular spline comprising an inner annular toothed portion;
a flexspline rotatably mounted within said circular spline, said flexspline comprising an outer annular toothed portion meshed with said inner annular toothed portion of said circular spline; and
a wave generator rotatably mounted within said flexspline, said wave generator comprising an elliptical outer perimeter abutted against an inner perimeter of said flexspline, the radius of curvature of said elliptical outer perimeter being defines as r·r=√x²+y², the relationship between x and y satisfying the elliptical parametric equation: x={a+Cₐ×(sin (4θ−(π/2))+1)}×sin θ, y={b+C_{b}×(sin (4θ−(π/2))+1)}×sin θ, 0≦θ≦2π, wherein a is the semi-major axis of the elliptical outer perimeter of said wave generator; Cₐ is the semi-major axis correction factor; b is the semi-minor axis of the elliptical outer perimeter of said wave generator; C_{b} is the semi-minor axis correction factor; θ is the eccentric angle of the elliptical outer perimeter of said wave generator.

2. The harmonic drive as claimed in claim 1, wherein the initial perimeter of the elliptical outer perimeter of said wave generator is S₀, S₀=∫₀^{2π}√φ_{θ}(r₀)²+r₀², r₀=√(a sin θ)²+(b sin θ)², 0=θ≦2π; the corrected perimeter of the elliptical outer perimeter of said wave generator is S·S=∫₀^{2π}√φ_{θ}(r)²+r²; the variable quantity of the elliptical outer perimeter of said wave generator before/after correction is E_{S}, E_{S}=S−S₀=0.1 m˜0.8 m, in which m is the modulus of said flexspline.

3. The harmonic drive as claimed in claim 2, wherein said circular spline and said flexspline have a same modulus therebetween.
